(19) United States
(12) Patent Application Publication
(10) Pub. No.: US 2025/0150863 A1
(43) Pub. Date: May 8, 2025

(54) METHOD AND SYSTEM FOR THE SIMULATION OF HAZARDS AT A DISTANCE

(71) Applicant: LAYER 3 SERVICES PTY LTD, FYSHWICK (AU)

(72) Inventors: Donald Stanley WILLIAMS, Carwoola (AU); James Edward Canterbury, Jannali (AU)

(21) Appl. No.: 18/836,671

(22) PCT Filed: Feb. 8, 2022
(86) PCT No.: PCT/AU2022/050068

§ 371 Date: Aug. 7, 2024

(51) Int. Cl. H04W 24/06; G01S 11/06; H04W 76/10

(52) U.S. Cl. CPC H04W 24/06; G01S 11/06; H04W 76/10

(57) ABSTRACT

A system (10) is disclosed for simulating an effect of a hazard at a distance. The system (10) may include a transmitter (12) configured to emit a radio frequency signal, such as a wireless network signal, carrying information representative of the hazard and at least one receiver (14) configured to receive the radio frequency signal and provide an indication or determination based on the information, of the effect of the hazard at the location of the at least one receiver (14). A related method is also disclosed.

### TECHNICAL FIELD

The invention relates to a method and a system for the simulation of a hazard at a distance from the hazard. In particular, the invention relates to a method and a system for simulating an effect of a hazard at a distance using network identifiers associated with a wireless signal, the hazard including, for example, an explosive, fire, chemical, biological and radiological event.

### BACKGROUND

The effect of a hazard at a distance from the hazard is of interest for variety of purposes such as the effect on people, infrastructure and vehicles, or other objects, exposed to the hazard. Such a hazard may be, but not limited to, an explosive, fire, chemical, biological and radiological event.

Because such hazards are considerably dangerous, it is not safe or practical to use live situations to understand the effect of the hazard such as for training purposes. Accordingly, there is a desire to simulate such hazards, especially for training purposes for persons involved for example: the military and emergency services and security managers and the effect on such people if in a hazard area.

One example of a hazard is an explosive blast, and it is of interest, for example, to understand the effect on persons within the hazard area, in this case a blast radius, such as the likely sustained injury due to the blast and fragmentation. Of course, use of a live explosives for training is extremely dangerous and as such there is a desire to simulate the explosive blast.

A problem with the simulation of hazards such as an explosive blast is providing realistic results that indicate the effect at distance from the particular hazards. Another problem relates to providing a robust and configurable system capable of field use, especially where there may be multiple hazards or effects to simulate, and the effects need to be indicated for several persons or objects spread throughout the hazard area.

The invention disclosed herein seeks to overcome one or more of the above identified problems or at least provide a useful alternative.

### SUMMARY

In accordance with a first broad aspect there is provided, a system for simulating an effect of a hazard at a distance. The system may include a transmitter configured to emit a radio frequency signal carrying information representative of the hazard and at least one receiver configured to receive the radio frequency signal and provide an indication or determination based on the information, of the effect of the hazard at the location of the at least one receiver.

In accordance with a second broad aspect there is provided, a system for simulating an effect of a hazard at a distance using network identifiers associated with a wireless signal of a wireless network, the system may include at least one transmitter and at least one receiver being configurable between, for example: an initial state in which the at least one transmitter is configured to selectively transmit the wireless signal including a first network identifier representative of the initial state and the at least one receiver is adapted to selectively receive the first network identifier and communicates status data with the at least one transmitter in the initial state; and a triggered state in which the at least one transmitter transmits the wireless signal including a second network identifier including data representative of the hazard that has been triggered, and the at least one receiver receives the second network identifier including the data representative of the hazard, and each at least one receiver determines a hazard effect based on the data representative of the hazard at the distance of the at least one receiver from the transmitter.

In an aspect, the data representative of the hazard carried by the second network identifier includes one or more hazard effect distances associated with one or more hazard effects.

In another aspect, the at least one receiver is configured to determine its distance from the at least one transmitter associated with the second network identifier in the triggered state, and determine one or more hazard effects at the one or more receivers based on the determined distance and the one or more hazard effect distances.

In yet another aspect, the at least one receiver is configured to at least one of indicate, store and communicate the determined one or more hazard effects.

In yet another aspect, the at least one receiver is configured to indicate a determined one or more hazard effects at the one or more receivers using at least one of a light and sound and vibration.

In yet another aspect, the at least one receiver is configured to at least temporarily store the determined one or more hazard effects and communicate the determined one or more hazard effects as with the at least one transmitter in the initial state.

In yet another aspect, the status data includes the determined one or more hazard effects.

In yet another aspect, the triggered state is initiated by a user action at or associated with the at least one transmitter.

In yet another aspect, in the triggered state, the transmitter is configured to transmit the second network identifier including data representative of the hazard over a predetermined hazard period, and then revert to the initial state or a further triggered state.

In yet another aspect, the predetermined hazard period is between 1 to 10 seconds.

In yet another aspect, the first network identifier and second network identifier are service set identifiers (SSIDs).

In yet another aspect, the SSIDs include at least a partially predetermined format identifiable by the at least one receiver to determine if the SSID is a first network identifier associated with the initiate state or a second network identifier associated with the trigger state.

In yet another aspect, the SSIDs of the second network identifier are configurable at the transmitter and are uniquely generated for each triggered state.

In yet another aspect, the SSIDs of the second network identifier are generated with a predetermined format in which groups of characters represent different hazard data.

In yet another aspect, a first group of the characters represents a type of the SSID being an SSID associated with the initiate state or the trigger state, and a second group of the characters represents one or more features of the triggered hazard.

In yet another aspect, the one or more features of the triggered hazard includes threshold distances at which a predetermined hazard effect occur at the at least one receiver.

In yet another aspect, in the initial state, the at least one receiver is adapted to connected with the at least one transmitter using the first network identifier at periodic intervals and disconnect from the at least one transmitter outside of the periodic intervals.

In yet another aspect, in the initial state, the at least one receiver is configured in an initial receiving mode in which network identifiers are receivable and is configured to enter a status mode in which the at least one receiver is adapted to connected with the at least one transmitter using the first network identifier at periodic intervals, and then disconnect from the at least one transmitter to re-enter the initial receiving mode.

In yet another aspect, each of the at least one receiver has a unique identifier readable by the at least one transmitter.

In yet another aspect, the unique identifier of each of the at least one receiver is a media access control (MAC) address.

In yet another aspect, the wireless signal has a frequency of 2.4 GHz other wireless network frequencies may be used to represent other specifical hazards.

In yet another aspect, the wireless network is an IEEE (Institute of Electrical and Electronics Engineers) 802 standard network, and preferably being a 802.11 standard network.

In yet another aspect, the system includes a plurality of the at least one transmitter and a plurality of the at least one receiver.

In accordance with a third broad aspect there is provided, a system for simulating an effect of a hazard at a distance using network identifiers associated with a wireless signal of a wireless network, the system including: a transmitter configured to selectively transmit: in an initial state, the wireless signal including a first network identifier representative of the initial state; and in a triggered state, the wireless signal including a second network identifier including data representative of the hazard that has been triggered; and at least one receiver configured to change between an: a status state in which the receiver selectively connects to the transmitter using the first network identifier to communicate status data with the transmitter in the initial state; and an activated state in which the receiver receives the second network identifier including data representative of the hazard, and determines a hazard effect based on the data representative of the hazard at the distance of the receiver from the transmitter.

In accordance with a fourth broad aspect there is provided, a method for simulating an effect of a hazard at a distance using network identifiers associated with a wireless signal of a wireless network, the method including: in an initial state, transmitting the wireless signal including a first network identifier representative of the initial state from at least one transmitter, and selectively receiving at one or more receivers the first network identifier to establish a first connection between at least one of the one or more receivers in which status data is communicated with the at least one transmitter; and in a triggered state, transmitting the wireless signal including a second network identifier representative of the triggered state from the at least one transmitter, and receiving at one or more receivers the second network identifier including the data representative of the hazard that is processable by the one or more receivers to determine a hazard effect of the hazard at the distance of the one or more receivers from the at least one transmitter.

In an aspect, the method further includes each of the one or more receivers: determining its distance from the at least one transmitter associated with the second network identifier in the triggered state; extracting one or more hazard effect distances from the data representative of the hazard; and determining one or more hazard effects at the one or more receivers based on the determined distance and the one or more hazard effect distances.

In another aspect, the method further includes at least one of indicating, and storing and communicating the determined one or more hazard effects at the one or more receivers.

In yet another aspect the method includes, in the initial state, the at least one receiver connecting with the at least one transmitter using the first network identifier at periodic intervals to communicate the status data, and disconnecting from the at least one transmitter outside of the periodic intervals.

In yet another aspect the method includes, in the triggered state, the transmitter transmitting the second network identifier including data representative of the hazard over a predetermined hazard period, and then returning to the initial state or a further triggered state.

In accordance with a fifth broad aspect there is provided, a system for simulating an effect of a hazard at a distance using network identifiers associated with a wireless signal of a wireless network, the system including at least one transmitter and at least one receiver being configurable between: a first state in which the at least one transmitter is configured to selectively transmit the wireless signal including a first network identifier representative of the initial state and the at least one receiver is configured to form a first connection with the at least one transmitter using the first network identifier and selectively communicate status data with the at least one transmitter; and a triggered state in which the at least one transmitter transmits the wireless signal including a second network identifier including data representative of the hazard that has been triggered, and the at least one receiver is configured to receive the second network identifier including the data representative of the hazard and determine a hazard effect based on the data representative of the hazard at the distance of the at least one receiver from the transmitter.

### BRIEF DESCRIPTION OF THE FIGURES

The invention is described, by way of non-limiting example only, by reference to the accompanying figures, in which;

FIG. 1 is a block diagram illustrating a system for the indication of hazards at a distance including one or more transmitters and one or more receivers;

FIG. 2 is a representative view illustrating an example a transmitter (Tx) of the system;

FIG. 3 is a block diagram illustrating the example a transmitter (Tx) of the system;

FIG. 4 is a representative view illustrating an example receiver (Rx) of the system;

FIG. 5 is a block diagram illustrating the example receiver (Rx) of the system

FIG. 6 is a flow diagram illustrating a method of simulation of hazards at a distance;

FIG. 7 is a flow diagram illustrating functions of the example transmitter (Tx) of the system using explosive as the simulated hazard;

FIG. 8 is a flow chart illustrating a transmit subroutine of the example transmitter (Tx) of the system; and

FIG. 9 is a flow diagram illustrating functions of the example receiver (Rx) of the system.

### DETAILED DESCRIPTION

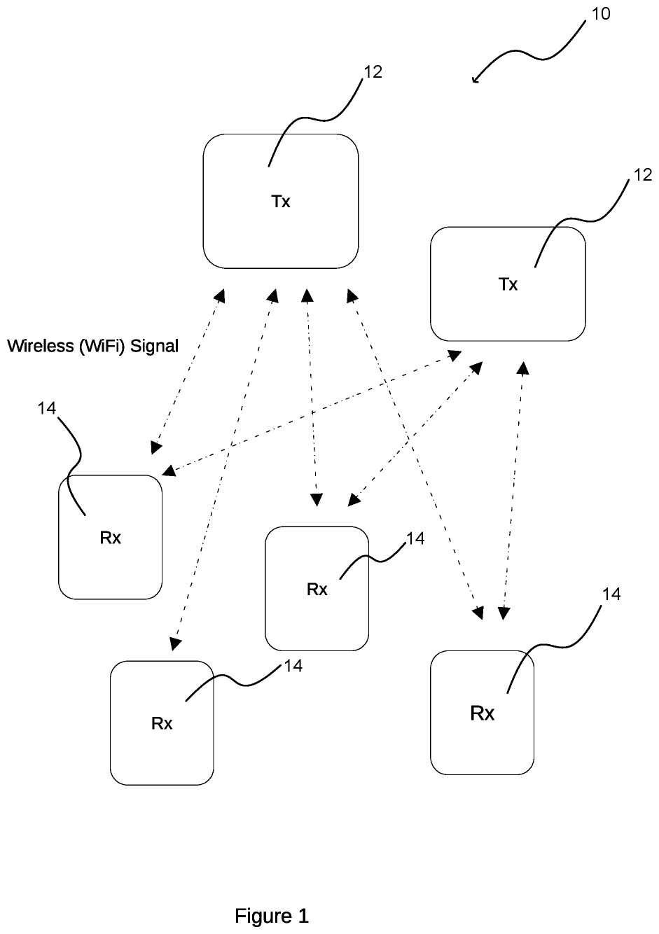

Referring to FIG. 1 there is shown an example of a system 10 for the simulation of a hazard at a distance from the hazard. The hazard may be, but not limited to, an explosive, fire, chemical, biological and radiological event. The system 10 includes one or more transmitters (Tx) 12 and one or more receivers (Rx) 14 that are adapted to communicate with one another.

The general of function of the system 10 is to provide a signal, in this example radio frequency (RF) signal, that is emitted from the one or more transmitters 12 that is received and processed by the one or more receivers 14 to provide an indication of the effect of the hazard at the location of the specific receiver 14, such as the effect on an object or person at the location of the specific receiver 14. For example, if the hazard is an explosive blast, the system 10 enables the simulation of the effect of the blast at the location of the receiver 14 as is further detailed below.

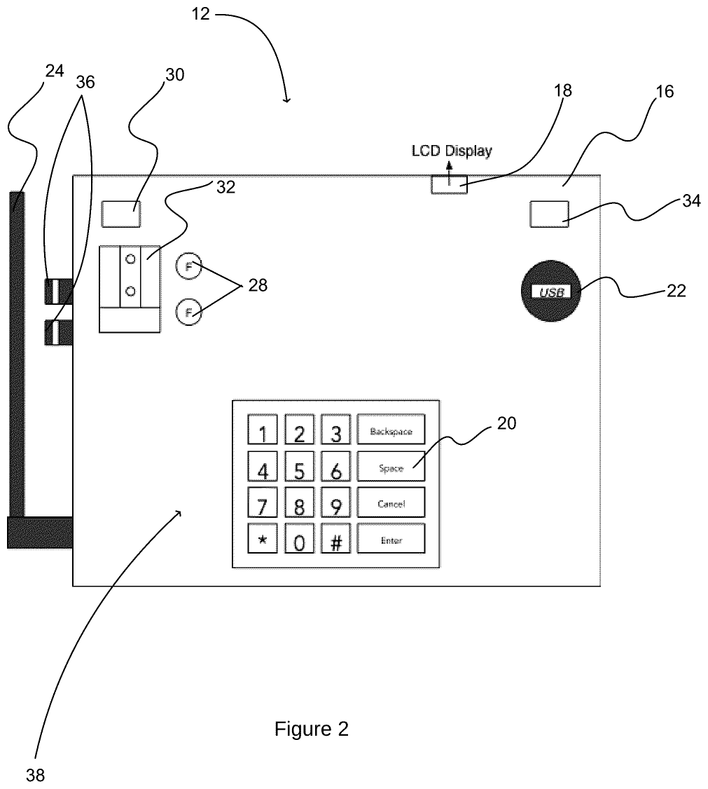

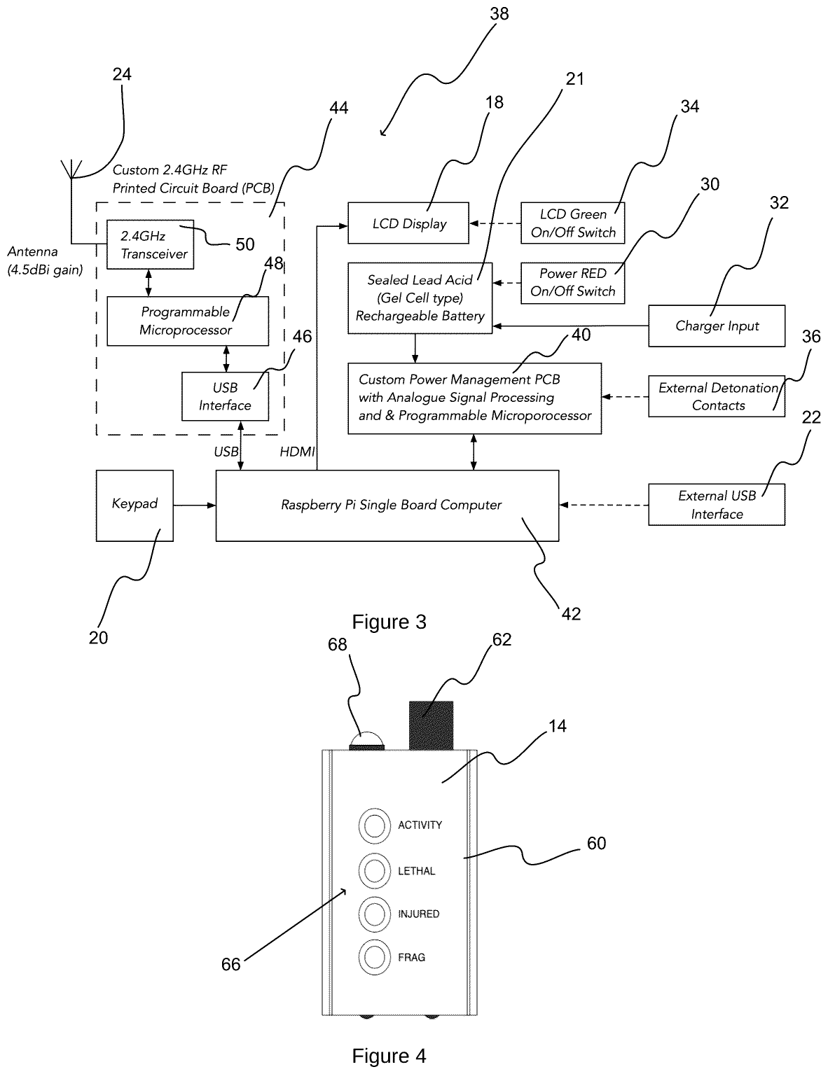

Referring to FIGS. 2 and 3, the transmitter 12 is shown in further detail. As shown in FIG. 2, the transmitter 12 includes a housing or case 16 that supports a display 18, a user interface such as a keypad 20, one or more batteries 21, an external data input/output means such as a USB port 22, an antenna 24, and fuses 28, an on/off switch 30, a charger connector 32, a screen on/off switch 34, firing connectors 36 and a control and communication arrangement 38 that further shown in FIG. 3. The firing connectors 36 (normally open contacts) may be used to connect to an activation switch, not shown, such as a firing button or the like.

Referring to FIG. 3, the control and communication arrangement 38 includes a first arrangement 40 including a power management printed circuit board (PCB) with analogue signal processing and a programmable microprocessor, a second arrangement 42 including a processor, and a third arrangement 44 that provides a radio frequency communication module including a USB interface 46, a microprocessor 48 and a transceiver 50 in communication with the antenna 24. The antenna 24 is an isotropic antenna. It is noted that the control and communication arrangement 38 may also take other forms that are configured to provide the same or similar functionality.

The system 10, including the transmitters 12 and receivers 14 preferably operate on an internationally available frequency that may use a frequency of 2.4 GHz. As such, in this example, the transceiver 50 and the antenna 24 are adapted for use at 2.4 GHz and the system 10 is generally configured to function in accordance with WiFi™ protocols, in this case Protocol 802.11b.

The use of WiFi protocols provides advantages to the system 10 in relation to how communication is handled between transmitters 12 and receivers 14, in particular where there are multiple receivers 14 that each may have a different effect from the hazard, or in situations where there are multiple transmitters 12 and receivers 14 simulating multiple effects of different hazards.

It is noted that signal frequency of 2.4 GHz meets the criteria of being able to pass through thin walls, reflect of hard surfaces and be reflected around corners, thereby emulating some of the effects of some hazards such as a blast. However, it is possible that other frequencies may be adopted to adapt the system 10 to other hazards, such as frequencies in the range of at least about 900 MHZ, 2.4 GHZ, 3.6 GHZ, 4.9 GHZ, 5 GHZ, 5.9 GHZ, 6 GHz and 60 GHz.

In this example, the system 10, namely the transmitted wireless signal by the transmitter 12, may have maximum range of about 250 m (˜820 feet) in free space which is adequate for most training scenarios and ensures the transmit power (at 2.4 GHz) is compliant to the WiFi standard.

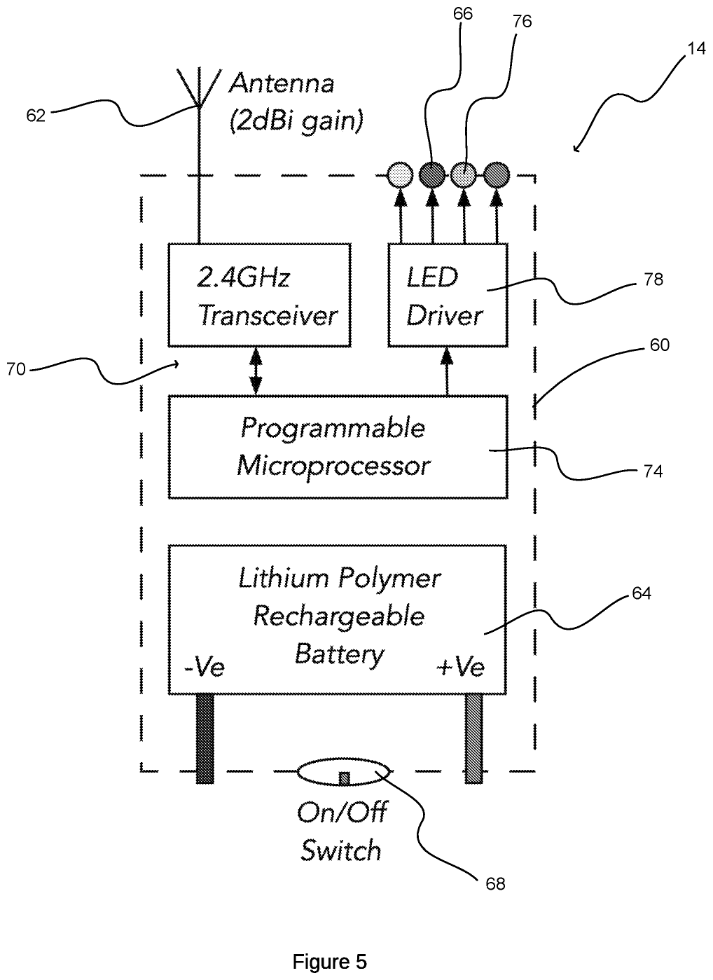

Referring now to FIGS. 4 and 5, the receiver 14 includes a housing 60 that supports an antenna 62, a battery 64 (Shown in FIG. 5), an indicator 66 of the hazard and an on/off switch 68. Internally of the housing 60 is provided a computing and communication arrangement 70 including a transceiver 72, in this example a 2.4 Ghz transceiver, in communication with a microprocessor 74. The indicator 66 may be provided in form of a visual or audible indicator and in this example is provided in the form of light emitted diodes (LEDs) 76 operative via a LED driver 78 which indicate the level of the effect of the hazard. The LEDs may be coloured to indicate the level of effect, such as “red” for a Lethal effect. For example, if the hazard is a blast, the LED lights may indicate an effect such as Activity (i.e there has been a blast), Lethal, Injured or Frag (i.e blast fragments). As such, any users of the receiver 14 may readily identify hazard exposure.

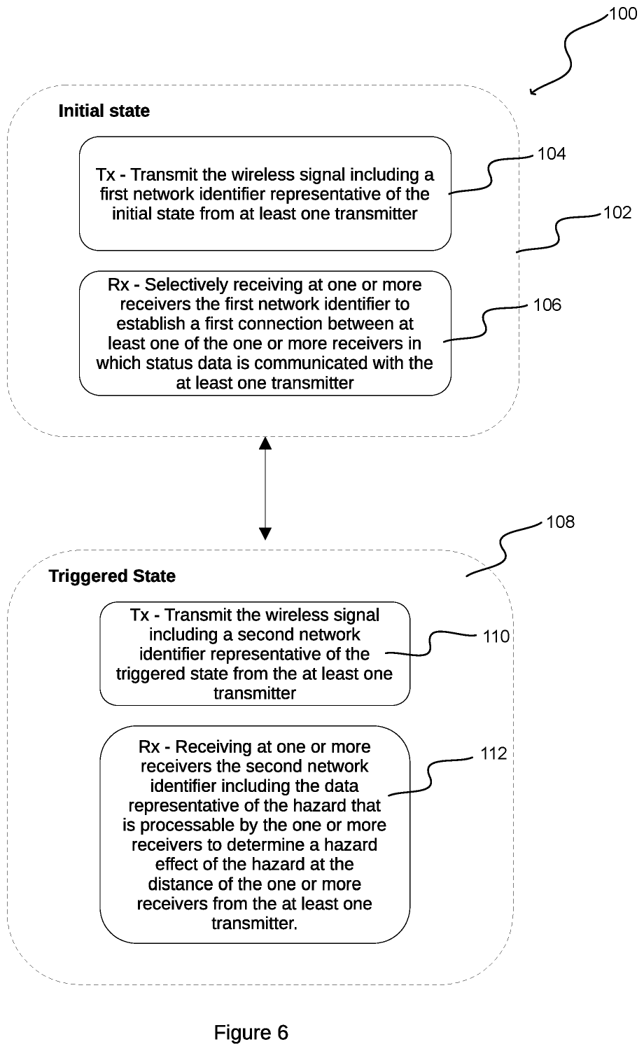

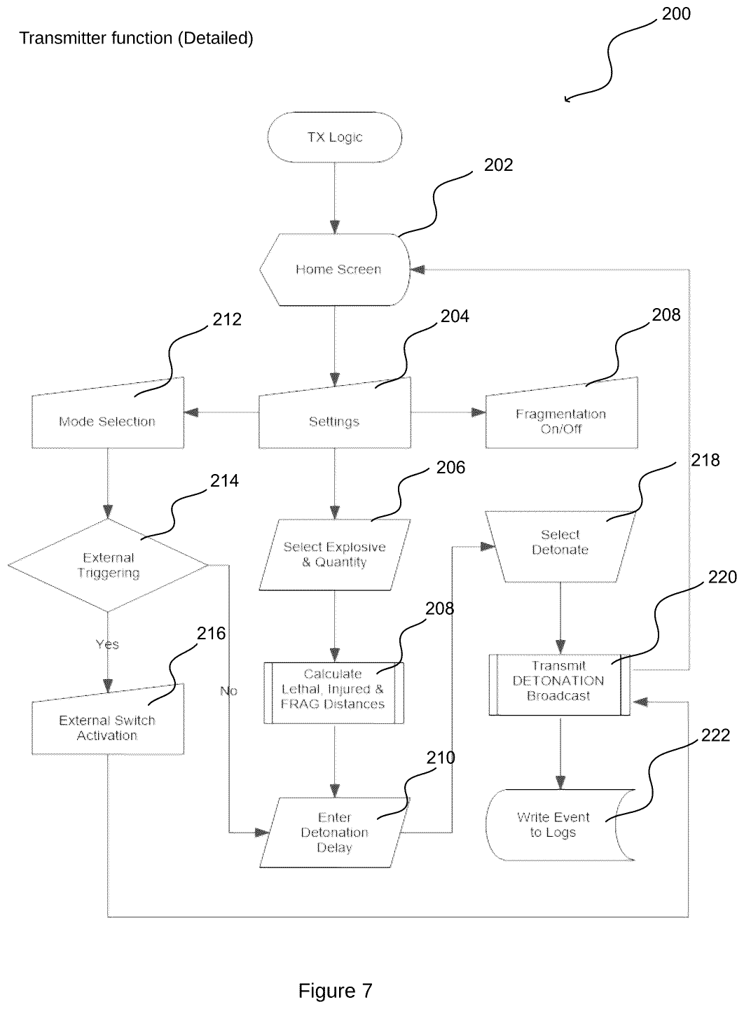

Referring to FIG. 6, a first example method 100 of operation of the transmitter 12 and receiver 14 is detailed. The transmitter 12 and receivers 14 are initially configured in an initial or default state at step 102, in which the transmitter 12 may at step 104 selectively transmit a first or initial signal including a first a network identifier. In this example, the first or initial signal transmitted by the transmitter 12 may be a network Wifi signal with an initial or first SSID (Service Set Identifier), otherwise known as a network identifier, in accordance the appropriate WiFi protocol.

In the initial or default state, at step 106 the receivers 14 are configured in a receiving state to listen for signals, including the first or initial signal emitted from the transmitter 12. When the first signal is being transmitted, any receivers 14 in range may be configured to connect to the network at predetermined intervals via the specific first identifier signal, in this case, the specific initial or first SSID.

In this initial state, once a connection is established, the receivers 14 may automatically connect and communicate, more specifically, upload receiver status data in a status mode to the transmitter 12. The receiver status data may include, for example, a message indicating the level of hazard to which the specific receiver 14 has been exposed as is further detailed below or simply an indication of the presence and operation status of the specific receiver 14.

The receivers 14 are configured to not be in constant communication with the transmitter 12, but are programmed to communicate at predetermined intervals only when communicating status data in the status mode, and then disconnect to listen for a hazard signal, such as a specific hazard SSID created by the transmitter 12 during the simulated hazard event, as is further detail below. This means, for example, that the receivers 14 do not need to be continuously connected to the transmitter 12 as would normally be the case with, say, a computer (desktop, laptop etc.) connected to an Office WLAN network or the like.

In more detail, the receivers 14 may be configured to enter the status mode at a predetermined interval that may approximately every 30 seconds. In the status mode, each receiver 14 communicates with the transmitter 14 to confirm its status via the status data sent to the transmitter 12, and then the receiver 14 disconnects and listens for any simulated hazard signal. The status data may take less than a second to propagate. A random time (jitter around the base 30 seconds) may be applied to permit the use of many receivers 14. It should be noted, the WiFi protocol was designed to support multiple remote devices simultaneously. Each of the receivers 14 has a unique identifier readable by the at least one transmitter 12. In this example, the unique identifier of each of the at least one receiver is a media access control (MAC) address.

Turning to a simulated hazard event and the trigger state 108, the transmitter 12 may be configured to create and transmit at step 110 the simulated hazard signal representative of a specific type and magnitude of hazard. For example, as further detailed, below the simulated hazard signal may be a second network identifier, more specifically an SSID, configured to include data specific to a type of hazard such as a blast and include information specific to that blast such as its specific blast effects. A user operating the transmitter 12 may elect to transmit the simulated hazard signal such as by pressing the button or the simulated hazard signal may be automatically configured to transmit such as via a timer or the like.

In more detail, the simulated hazard signal may be a specific and unique SSID that includes data specific to the type and nature of the hazard event. In this example, the SSID may take the form: xDET_LLLLL_IIIII_FFFFF. In which: LLLLL is the LETHAL distance in metres to two decimal points. The decimal point is removed from the transmission. e.g. 12.34 m (Note, only the distance magnitude is transmitted not the preceding zeros for the hundreds amount or the tens amount e.g. 3.42 m); and IIIII is the INJURY distance in metres to two decimal points. The decimal point is removed from the transmission. e.g. 34.97 m (Note, only the distance magnitude is transmitted not the preceding zero for the hundreds amount); and FFFFF is the fragmentation effect (FRAG) distance in metres to two decimal points. The decimal point is removed from the transmission e.g. 234.65 m (If FRAG is turned OFF, the FRAG value is zero ‘0’). Accordingly, this example would result in a unique simulated hazard signal in which the network identifier, SSID, has the form: xDET_1234_3497_23465. It is noted that the leading part of the SSID “xDET” provides a signal type identifier (in this case identifying a detonation event) that enables the receivers 14 to recognise that the network identifier, SSID, relates to a hazard event and that the SSID will contain hazard information. Other forms of the leading signal type identifier may be used to identify different types of hazards. The signal type identifier also assists the receivers 14 to differentiate between different network signals

The receivers 14 configured to listen for the simulated hazard signal are configured to receive and process the simulated hazard signal at step 112 in the triggered state. In particular, the receivers 14 are configured to process the data carried by the SSID and use this data to determine the effect at the receivers 14, and may operate the appropriate indicators at the receiver 14 to indicate at the receiver 14 the effect of the simulated hazard at the receiver 14 location.

In this regard, it is noted that the processing of the simulated hazard signal includes determining a received signal strength in comparison to the known transmitted signal strength and estimating the effective distance of the respective receivers 14 from the transmitter 12 transmitting the simulated hazard signal. The receivers 14 may also be configured to process, record and then transmit results data, such as the determined hazard level at the specific receivers 14 when the receivers enter the periodic status mode as described above.

It is noted that the use of WiFi network protocols, such as the unique SSIDs is advantageous in this application as it enables the system 10 to be easily configured to different types of hazards, and allows multiple transmitters 12 and receivers 14 to be used simultaneously. In particular, by configuring the system 10, namely the receiver 14 to listen for different SSIDs and selectively connecting and disconnecting means that the transmitters 12 and receivers 14 are not always connected, and allows, for example, for receivers 14 to listen for multiple transmitters 12 which facilities multiple hazard type simulations.

Referring now to FIG. 6, an example method of implementation of an indication of a hazard at a distance is provided in which the hazard is an explosive event. The general steps are similar to those set out above in relation to the method 100. However, in this example, further detailed in relation to the method 200 of configuration of the transmitter 12 are provided.

At step 202, a user may start with the home screen of the display 18 and provide input or make selections, such as via the keypad 20 at step 204 from preconfigured data in relation to an explosive from a list of commercial, military and home-made explosives then an amount (a magnitude) of explosive between 0.1 and 20,000 kg (˜ 0.2 to 44,000 pounds) is selected at step 206. An optional setting at step 208 allows fragmentation to be considered for the selected explosive. The transmitter 12 is configured to determine, such as by using its control and communication arrangement 38, based on the selected explosive and quantity, the outer ranges (threshold distances in metres) at which the indicated effects will be experienced under ideal conditions. Metric or US units of measure can be selected via a menu option. These effects being, for example:
a. 207 kPa (˜30 psi) as the threshold damage level of lung damage, considered to be the outer distance for blast lethality and represented by the Red LED on the RX;
b. 34 kPa (˜5 psi) as the threshold damage for ear damage, considered to be the outer distance for blast injury represented by the Orange LED on the receiver 14;
c. >70 kPa (>10 psi) reflected pressure indicating severe structural damage, also represented by the Orange LED on the receiver 14 and
d. The probability of a fragmentation impact of greater that 79 Joules represented by the Blue LED on the receiver. The fragmentation indication can be turned on or off by a setting if not required for the scenario.

The following exemplary blast tables present the pressures expected to be experienced by the target at set distances. These are ‘Peak Incident Pressures’ i.e. the initial impact of the blast as it passes over/around the person. It is not expected that there will be much resistance to the blast so ‘Reflected Pressure’ is not shown.

Anyone closer than the shown distances can be expected to have suffered injury. It is noted that the receiver 14 should be configured to not respond beyond these distances for the selected charge weight. The pressures of 207 kPa and 34 kPa are taken from US Federal Emergency Management Agency FEMA 426 “Reference Manual to Mitigate Potential Terrorist Attacks Against Buildings” Table 3.1 quoting US Department of Defence 3-340-02, “Structures to Resist the Effects of Accidental Explosions” (2008b). The figure of 5 psi for threshold of ear damage is converted to 34 kPa; the figure of 30 psi for threshold of lung damage converted to 207 kPa. These figures are considered accurate enough for the explosion simulation system to emulate blast effects.

The pressure/distance figures were calculated using US WES CONWEP TM5-855, a well validated model. Figures are rounded to nearest metre.

TABLE 1
Pressure/Distance:

| | Ear damage | Lung damage |
|---|---|---|
| | threshold | threshold |
| Charge weight | (~34 kPa) | (~207 kPa) |
| in kg (TNT) | in ~m | in ~m |
| 2 | 7 | 3 |
| 5 | 10 | 4 |
| 10 | 13 | 5 |
| 25 | 17 | 7 |
| 50 | 21 | 8 |
| 100 | 27 | 11 |
| 200 | 34 | 13 |
| 250 | 36 | 15 |

The calculations assume: Full detonation of the well-constructed explosive material; Hemispherical surface burst; No increase of pressure due to reflective surfaces. The figures do not include damage and injury from fragmentation.

TABLE 2
Fragmentation Table

| Type | Range |
|---|---|
| 155 mm | 150 metres |
| 105 mm | 150 metres |
| 120 mm Mortar | 76 metres |
| 81 mm Mortar | 55 metres |
| 60 mm Mortar | 40 metres |
| Hand Grenade | 15 metres |

The transmitter 12 is then configured to use predetermined data, such as the data provided in Tables 1 and 2 to determine hazard data including distances in meters for including into the network identifier as detailed above (i.e SSID has the form: xDET_1234_3497_23465). The distances may include, but are limited to, a lethal distance, an injured distance, and a fragment exposure distance.

At step 212 a user may select a number of ‘modes’. The modes offer variations designed to suit various scenarios. The appropriate mode is selected via a menu of the transmitter 12, example modes may include: Bomb Technician Mode, designed to assist bomb technicians and explosive ordnance disposal operators and their supervisors, the signal is initiated by an external trigger Search Mode, designed for high-risk search and assault teams and their supervisors where multiple explosives including booby traps and breaching charges may be simulated; and Blast Assessment Mode, designed for security, safety managers, wardens, consultants and engineers who require an appreciation of explosive effects over distance. Initiated using the in-built timer (delay).

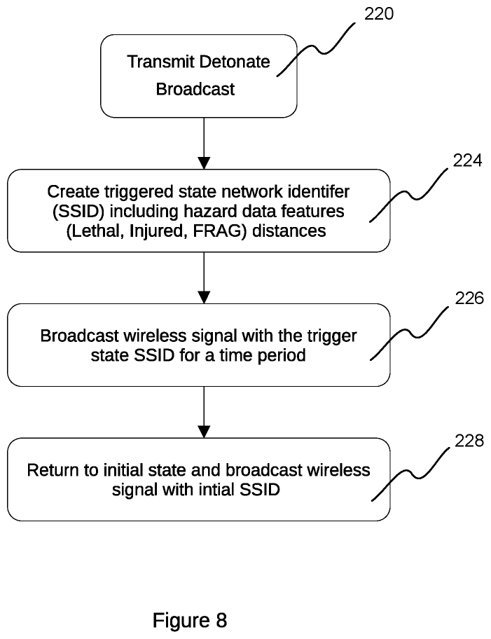

At step 214 the system 200 automatically selects (based on mode User selection) either external triggering such as by an external active switch at step 216 or enter a detonate delay at step 210. The user may then select to detonate at step 218 in which the transmitter enters the triggered state and transmits the simulation blast signal at step 220. As shown in FIG. 8, the transmission of the simulation blast signal at step 220 requires, at step, 224 includes changes the network identifier to a newly created network identifier, in this case a triggered SSID format, that the receivers 14 are configured to recognise as a simulated blast signal. The triggered SSID format includes hazard data such as distances as outlined above (i.e. xDET_1234_3497_23465) and this signal is broadcast in the triggered state for a period of time at step 226, that may be only in the range of 1 to 10 seconds to simulate a blast. The transmitter 12 is then configured, at step 228, to return to the initial state where receivers 14 may connect with and report status data to the transmitter 12.

It is noted that in this example, the transmitter 12 does not change the transmitted strength of the signal which remains the same to have a range in the order of about 250 meters are outlined above. The system 200 has a real-time clock to permit the local time entry for the scenario log files ultimately stored at step 222. Simulated explosion events are originated only by the transmitter 12.

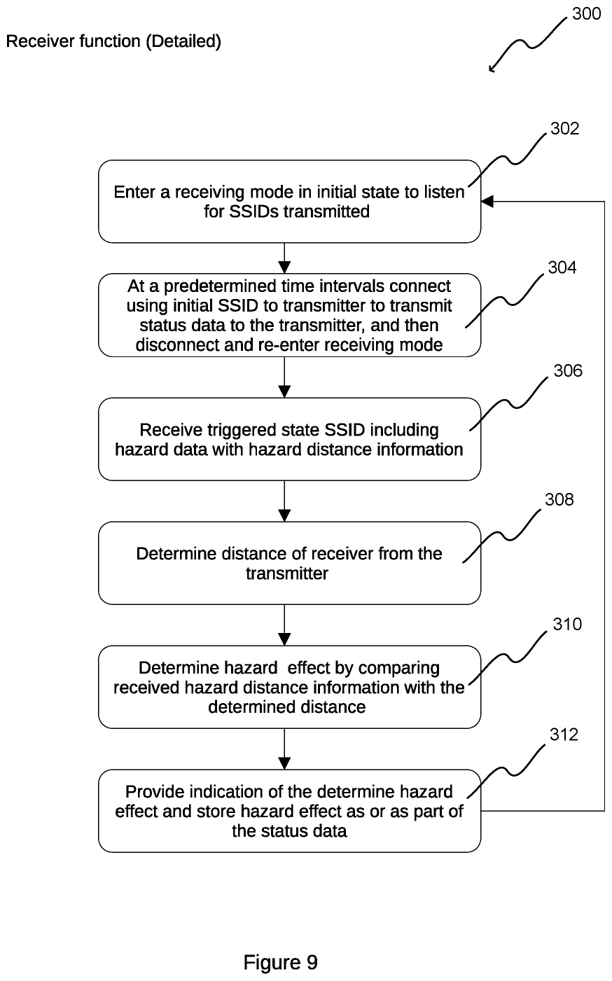

Referring now to FIG. 9, a more detailed method 300 of the function of the receiver 14 is provided as executed by the microprocessor 74 of the receiver 14. At step 302, the receiver is initially in a receiving mode in the initial state to listen for network identifiers, namely SSIDs, transmitted. At step 304, At predetermined time intervals, that may be about 30 seconds, the receivers 14 connect using the initial or default SSID to transmitter 12 to transmit status data to the transmitter, and then disconnects and re-enters the receiving mode. The cycle may continue for all receivers 14 in the initial state.

The simulated explosion signal broadcast is received by the receiver 14 at step 306 that includes the triggered state SSID including the hazard data with the hazard distance information. The receiver 14 then processes or decodes the broadcast, namely the data encoded into the SSID, using the microprocessor 74 to determine threshold distances. At step 308, the receiver 14 is configured by software executed by its microprocessor 74 to determine its effective distance from the transmitter 12 based on the received signal strength.

At step 310 the receiver 14 then compares its effective distance to the received threshold values to determine an appropriate effect at step 312, in this example, an indication of the LEDs. The receiver 14 LED indication equates to blast lethality, blast injury, severe structural damage or fragment injury for that simulated explosion event. For example, if the lethal threshold is 50 meters and the determined distance is 45 meters, then the LED indication will be a lethal level e.g. the Red LED will turn on. The values of the hazard effect may be stored as a simulation effect data set at each receiver 14.

If a second or further simulated explosion event occurs the receiver 12 will repeat the analysis and determine if the LED indication needs to be escalated (Orange to Red indication). Similarly, if the first simulated explosion has fragmentation OFF then the receiver 14 Blue LED will be off then if a second simulated explosion event occurs and fragmentation is ON then the Blue LED will turn on. This logic allows for the escalation of potential injuries for the same receiver 14 in the scenario.

The receivers 14 may then return to the initial state at step 302, and may transmit status data to the transmitted 12 that may now include the simulation effect data resulting from the simulated blast. This simulation effect data may then be stored and further processed at or via the transmitter 12.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any known matter or any prior publication is not, and should not be taken to be, an acknowledgment or admission or suggestion that the known matter or prior art publication forms part of the common general knowledge in the field to which this specification relates.

While specific examples of the invention have been described, it will be understood that the invention extends to alternative combinations of the features disclosed or evident from the disclosure provided herein.

Many and various modifications will be apparent to those skilled in the art without departing from the scope of the invention disclosed or evident from the disclosure provided herein.

1. A system for simulating an effect of a hazard at a distance using network identifiers associated with a wireless signal of a wireless network, the system including at least one transmitter and a plurality of receivers each having a unique identifier readable by the at least one transmitter, the system being configurable between:
an initial state in which the at least one transmitter is configured to selectively transmit the wireless signal including a first network identifier representative of the initial state and each of the plurality of receivers is adapted to selectively receive the first network identifier and communicate status data with the at least one transmitter in the initial state; and
a triggered state in which the at least one transmitter transmits the wireless signal including a second network identifier including data representative of the hazard that has been triggered, and each of the plurality of receives the second network identifier including the data representative of the hazard, and each of the plurality of receivers determines a hazard effect based on the data representative of the hazard and a received strength of the wireless signal at the distance of each of the plurality of receivers from the at least one transmitter,
wherein, in the initial state, each of the plurality of receivers is configured in an initial receiving mode in which network identifiers are receivable, and are configured to enter a status mode at periodic intervals in which each of the plurality of receivers is adapted to selectively connect with the at least one transmitter using the first network identifier and its unique identifier to communicate the status data, and then disconnect from the at least one transmitter to re-enter the initial receiving mode.

2. The system according to claim 1, wherein the data representative of the hazard carried by the second network identifier includes one or more hazard effect distances associated with one or more hazard effects.

3. The system according to claim 2, wherein each of the plurality of receivers is configured to determine its distance from the at least one transmitter associated with the second network identifier in the triggered state, and determine one or more hazard effects at each of the plurality of receivers based on the determined distance and the one or more hazard effect distances.

4. The system according to claim 3, wherein each of the plurality of receivers is configured to at least one of indicate, store and communicate the determined one or more hazard effects.

5. The system according to claim 4, wherein each of the plurality of receivers is configured to indicate a determined one or more hazard effects at one or more receivers of the plurality of receivers using at least one of a light and sound and vibration.

6. The system according to claim 4, wherein each of the plurality of receivers is configured to at least temporarily store the determined one or more hazard effects and communicate the determined one or more hazard effects with the at least one transmitter in the status mode.

7. The system according to claim 6, wherein the status data includes the determined one or more hazard effects.

8. The system according to claim 1, wherein the triggered state is initiated by a user action at or associated with the at least one transmitter.

9. The system according to claim 1, wherein in the triggered state, the transmitter is configured to transmit the second network identifier including data representative of the hazard over a predetermined hazard period, and then revert to the initial state or a further triggered state.

10. The system according to claim 9, wherein the predetermined hazard period is between 1 to 10 seconds.

11. The system according to claim 1, wherein the first network identifier and second network identifier are service set identifiers (SSIDs).

12. The system according to claim 11, wherein the SSIDs include at least a partially predetermined format identifiable by plurality of receivers to determine if the SSID is a first network identifier associated with the initiate state or a second network identifier associated with the trigger state.

13. The system according to claim 11, wherein the SSIDs of the second network identifier are configurable at the transmitter and are uniquely generated for each triggered state.

14. The system according to claim 13, wherein the SSIDs of the second network identifier are generated with a predetermined format in which groups of characters represent different hazard data.

15. The system according to claim 14, wherein a first group of the characters represents a type of the SSID being an SSID associated with the initiate state or the trigger state, and a second group of the characters represents one or more features of the triggered hazard.

16. The system according to claim 15, wherein the one or more features of the triggered hazard includes threshold distances at which a predetermined hazard effect occurs at each of the plurality of receivers.

17. (canceled)

18. (canceled)

19. (canceled)

20. The system according to claim 19, wherein the unique identifier of each of each of the plurality of receivers is a media access control (MAC) address.

21. The system according to claim 1, wherein the wireless signal has a frequency of 2.4 GHz.

22. (canceled)

23. (canceled)

24. (canceled)

25. A method for simulating an effect of a hazard at a distance using network identifiers associated with a wireless signal of a wireless network, the method including:
in an initial state, transmitting the wireless signal including a first network identifier representative of the initial state from at least one transmitter, and selectively receiving at a plurality of receivers the first network identifier to establish a first connection with each receiver of the plurality of receivers in which status data is communicated with the at least one transmitter; and
in a triggered state, transmitting the wireless signal including a second network identifier representative of the triggered state from the at least one transmitter, and receiving at one or more receivers of the plurality of receivers, the second network identifier including data representative of the hazard and a received strength of the wireless signal that is processable by the one or more receivers to determine a hazard effect of the hazard at the distance of the one or more receivers from the at least one transmitter,
wherein, in the initial state, each receiver of the plurality of receivers is configured in an initial receiving mode in which network identifiers are receivable and are configured to enter a status mode in which each of the plurality of receivers is adapted to selectively connect with the at least one transmitter at periodic intervals using the first network identifier and a unique identifier associated with each of the plurality of receivers to transmit the status data, and then disconnect from the at least one transmitter to re-enter the initial receiving mode.

26.-30. (canceled)
